(19) United States
(12) Patent Application Publication
(10) Pub. No.: US 2013/0316889 A1
(43) Pub. Date: Nov. 28, 2013

(54) CENTRIFUGE, ROTOR FOR CENTRIFUGE, AND SAMPLE CONTAINER FOR CENTRIFUGE

(71) Applicant: HITACHI KOKI CO., LTD., Tokyo (JP)

(72) Inventors: Ken ASAKURA, Hitachinaka (JP); Kenichi NEMOTO, Hitachinaka (JP); Yoshimitsu KITAZAWA, Hitachinaka (JP)

(73) Assignee: HITACHI KOKI CO., LTD., Tokyo (JP)

(21) Appl. No.: 13/901,265

(22) Filed: May 23, 2013

(30) Foreign Application Priority Data
May 23, 2012 (JP) 2012-117322
Apr. 16, 2013 (JP) 2013-085703

(51) Int. Cl. B04B 7/08

(52) U.S. Cl. CPC B04B 7/08
USPC 494/43; 422/548

(57) ABSTRACT

A sample container includes a body part which can accommodate a sample and a cap part that can be mounted on the non-circular body part. On the cap part, a neck support member is set for filling a space between an outer lid and a holding hole of a rotor body. The neck support member is configured to be able to be attached to and removed from the outer lid and to be able to relatively rotate with respect to the outer lid. By mounting the outer lid on the body part, the neck support member can also be mounted at the same time. The neck support member is arranged so as to be interposed between the outer lid and shoulder parts of the body part in an axial direction. The neck support member has a lower surface formed so as to correspond to the shape of the shoulder parts.

### CROSS-REFERENCE TO RELATED APPLICATION

The present application claims priorities from Japanese Patent Application No. 2012-117322 filed on May 23, 2012, and Japanese Patent Application No. 2013-085703 filed on Apr. 16, 2013, the contents of which are hereby incorporated by reference into this application.

### TECHNICAL FIELD OF THE INVENTION

The present invention relates to centrifuges for use in the fields of medical science, pharmaceutical science, genetic engineering, and others, and relates to a sample container in a cylindrical or non-cylindrical shape for a centrifuge (a centrifugal machine) having an angle rotor.

### BACKGROUND OF THE INVENTION

A centrifuge for use in separation of a liquid sample includes a rotor which holds a plurality of sample containers having the liquid sample accommodated therein in sample-container holding holes equally arranged on the circumference of a circle and a driving means such as a motor for driving the rotor for rotation. With the rotor rotating at a high speed under atmospheric pressure or a reduced pressure in a rotor chamber, the liquid sample in the sample containers is centrifuged to collect a target substance.

A rotor for a centrifuge has been known from, for example, Japanese Patent Application Laid-Open Publication No. 2008-119649 (Patent Document 1). FIG. 12 illustrates aside view of an existing angle-type rotor 130, and its section is illustrated in a right-half portion of the drawing. In FIG. 12, a rotor body 131 of the rotor 130 has a plurality of holding holes 132 for sample containers (only one hole is illustrated in FIG. 12) formed with equiangular pitches along the circumference of a circle. In each holding hole 132, a sample container 150 filled with a liquid sample is inserted. The rotor 130 has a top opening where a rotor cover 140 is mounted. With the rotor cover 140 fixed to the rotor body 131 with a handle 141, a sample holding space in the rotor 130 is sealed. The rotor body 131 also has a fitting hole 131A at a lower part of the center axis. In this fitting hole 131A, a driving shaft 112 of the centrifuge is inserted, and the rotor 130 is rotated at a predetermined speed by a driving means.

FIG. 13 is a perspective view of the shape of an existing sample container 150 which has been known from Japanese Patent Application Laid-Open Publication No. 2004-290746. Normally, in a centrifuge using a lid-equipped sample container, its body part 151 has a cylindrical shape. A screwed-type lid 152 is mounted on the top of the body part 151 to seal a liquid sample. The lid 152 is configured of an outer lid 153 and an inner rid 154. The outer lid 153 has a plurality of projections 153B formed on its outer circumferential surface and equidistantly arranged in a circumferential direction so as to allow an operator to easily turn the lid. Normally, the sample container 150 is a molded product using a plastic material such as polypropylene, polycarbonate, polystyrene, or polyethylene terephthalate, and it is often the case that such sample container 150 is used many times. The body part 151 and the lid 152 each have a round cross section. When inserted in the holding hole 132 of the rotor 130, the sample container 150 can be mounted at any position without concern for the rotation position with reference to the center axis of the sample container 150 in a longitudinal direction. Here, the term “cross section” refers to a section obtained by cutting along a plane perpendicular to an axial direction (a vertical direction) of the sample container.

Conventionally, each lid-equipped sample container 150 for use in the angle-type rotor 130 has a capacity of 2 ml to 1,000 ml in practical use, according to the intended purpose. Also, the number of holding holes 132 for sample containers formed in each rotor 130 is varied from about four to twenty. In general, the rotor 130 is manufactured by using a light-weight, high-strength aluminum alloy, titanium alloy, carbon-fiber composite material, or others. Commercially-available examples of the rotor 130 include a rotor that can accommodate six sample containers each having a capacity of 300 ml (hereinafter referred to as six 300-ml sample containers), a rotor that can accommodate six 500-ml sample containers, and a large-capacity angle rotor that can accommodate four to six 1,000-ml sample containers. With changes of the times, the capacity of each sample container has been increased. With the increase in capacity of the sample container, the size of the rotor body has also been increased. For example, a rotor for 300-ml to 1,000-ml sample containers has a size with a maximum diameter of its rotor body substantially exceeding 300 mm.

Meanwhile, the rotor is attached to and removed from the centrifuge by an operator. Centrifuge manufacturers including the applicant have been endeavoring to reduce weight and improve operability of the rotor by contriving the structure of the rotor. Furthermore, with an increase in size of the sample container, the sample capacity that can be centrifuged at one time has been increased. In recent years, a centrifuge using a large-capacity angle rotor that can accommodate four 1,000-ml sample containers has been widely used. Also, a sample container disclosed is equipped with a lid as disclosed in Japanese Patent Application Laid-Open Publication No. 2004-290746 (Patent Document 2) to prevent leakage of a sample during centrifuging, and the lid 152 has a through hole 153A for removal (refer to FIG. 14) formed therein to allow easy removal of the sample container. As illustrated in FIG. 14, the outer lid 153 has an annular lower side surface 153C in a shape so as not to be in contact with the body part 151.

Related art is also disclosed in Japanese Patent Application Laid-Open Publication No. 2011-11131 (Patent Document 3).

### SUMMARY OF THE INVENTION

In general, to efficiently collect target substances from a liquid sample in a centrifugal process, the rotation speed of the rotor is increased to increase the centrifugal acceleration to be applied to the liquid sample to enhance a centrifugal effect so that the target substances are quickly settled, or the amount of the sample that can be processed at one time is increased so that a collection ratio is improved. Also, for a reduction in cost for a centrifugal operation, it is important to not only inexpensively configure a centrifuge including sample containers and a rotor but also increase the sample amount that can be centrifuged at one time to increase the amount of work done. To centrifuge a large amount of the liquid sample at one time, it is effective to increase the number of sample containers for use in the rotor and to increase the capacity of each sample container. However, to increase the capacity of the conventional cylindrical sample container, the outer diameter or the height of the body part 151 has to be increased. In that case, interference occurs between adjacent sample-container holding holes of the rotor, and therefore the arrangement positions of the holding holes have to be shifted away from the rotation center in a radial direction (to an outer circumferential side). As a result, the diameter of the rotor itself is increased to increase the mass, thereby degrading portability of the rotor by the operator and attachability to the centrifuge.

The increase in diameter of the rotor leads to an increase in air resistance (windage loss) at the time of high-speed rotation in the centrifuge. To address this, the output of a driving device of the centrifuge has to be increased, and the output of a cooling device part for cooling the rotor has to be increased. Moreover, with the increase of the diameter of the rotor, the size of the rotor chamber of the centrifuge has to be also increased, thereby posing problems of increasing the installation area of the centrifuge and increasing the price of the centrifuge. In the course of solving these problems, the inventors paid attention to the fact that a component portion of the rotor causing an increase in weight (hereinafter referred to as a “superfluous portion”) is present between adjacent sample-container holding holes when the rotor having cylindrically-shaped sample containers arranged therein is viewed from above, and tried an improvement of reducing this superfluous portion as much as possible. Furthermore, in the course of this improvement, the inventors found that a superfluous portion near the outer circumference of the rotor is a cause of increasing the mass of the rotor and a centrifugal load applied to this superfluous portion is a factor in decreasing the strength of the rotor.

The present invention has been made in view of the background described above, and a preferred aim of the present invention is to prevent a sample container for a centrifuge, having an increased sample amount that can be centrifuged at one time, from being broken or degraded due to a centrifugal force at the time of operation.

Another object of the present invention is to provide a sample container for a centrifuge having a body part and a circular lid part, the sample container provided with a neck support member which restricts movement and deformation of the lid part due to centrifugal force.

Still another object of the present invention is to provide a sample container for a centrifuge, the sample container which can prevent a neck support member from not being mounted, does not reduce its useful life, and is excellent in durability and usability.

The typical ones of the inventions disclosed in the present application will be briefly described as follows.

According to an embodiment of the present invention, a sample container for a centrifuge includes: a body part capable of accommodating a sample; an outer lid mountable on the body part; and a neck support member provided on an outer circumferential side of the outer lid for filling a space between an outer circumferential surface of the outer lid and a holding hole of a rotor of the centrifuge, the body part having a circular opening on top and the outer lid being attachable to and removable from the opening by screwing via a sealing member, the neck support member having an outer circumference substantially identical in shape to the body part when viewed from above, and the neck support member being arranged so as to be interposed between the outer lid and the body part when the outer lid is mounted on the body part.

According to another embodiment of the present invention, a sample container for a centrifuge includes: a body part capable of accommodating a sample; a lid part mountable on the body part; a neck support member provided on an outer circumferential side of the lid part for filling a space between an outer circumferential surface of the lid part and a holding hole of a rotor of the centrifuge, the body part having a non-circular outer shape when viewed from above and having a circular opening on top, the lid part being attachable to and removable from the opening by screwing via a sealing member, the neck support member having a non-circular outer shape identical to the shape of the body part when viewed from above, and the neck support member being arranged so as to be interposed between the outer lid and the body part when the outer lid is mounted on the body part.

According to the present invention, the outer circumference of the neck support member has a shape substantially identical to the shape of the body part when viewed from above and, the neck support member is arranged so as to be interposed between the outer lid and the body part when the outer lid is mounted on the body part. In this manner, the centrifugal force exerted on the outer lid can be effectively supported by the neck support member. Therefore, it is possible to prevent the sample container for the centrifuge from being broken or degraded due to the centrifugal force.

According to the present invention, the neck support member has a non-circular outer shape identical to the shape of the body part when viewed from above and, with the lid part mounted on the body part, the neck support member is interposed between the lid part and the body part. In this manner, the centrifugal force exerted on the lid part can be supported also by the support member. Therefore, it is possible to prevent the sample container for the centrifuge from being broken or degraded due to the centrifugal force.

The above and other preferred aims and novel characteristics of the present invention will be apparent from the description of the present specification and the accompanying drawings.

### BRIEF DESCRIPTIONS OF THE DRAWINGS

FIG. 1 is a front view of a centrifuge according to a first embodiment of the present invention, with its part illustrated in a cross-sectional view;

FIG. 2 is a longitudinal cross-sectional view of a rotor 30 of the first embodiment of the present invention;

FIG. 3 is a perspective view of a rotor body 31 according to the first embodiment of the present invention;

FIG. 4 is a top view of the rotor body 31 according to the first embodiment of the present invention;

FIG. 5 is a perspective view of an outer appearance of a sample container 50 according to the first embodiment of the present invention;

FIG. 6 is an exploded perspective view of a structure of a cap part 52 of the first embodiment of the present invention;

FIG. 7 is a diagram illustrating a shape of a neck support member 70 of the first embodiment of the present invention, including (1) a perspective view viewed from above, (2) a perspective view viewed from bottom, and (3) a top view;

FIG. 8 is a partial longitudinal cross-sectional view of a state of the sample container at the time of operation of a rotor in the first embodiment of the present invention;

FIG. 9 is a perspective view of an outer appearance of a sample container 250 of a second embodiment of the present invention;

FIG. 10 is a diagram illustrating a shape of a neck support member 270 of the second embodiment of the present invention, including (1) a perspective view viewed from above, (2) a perspective view viewed from bottom, and (3) being a top view;

FIG. 11 is a partial longitudinal cross-sectional view of a state of the sample container 250 at the time of operation of a rotor in the second embodiment of the present invention;

FIG. 12 is a longitudinal sectional side view of a rotor 130 of a conventional example;

FIG. 13 is an external perspective view of a sample container 150 of the conventional example; and

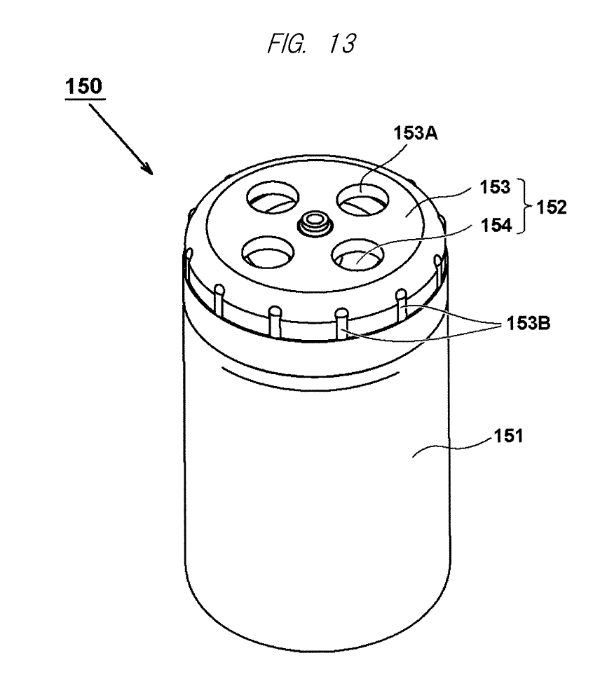

FIG. 14 is a partial longitudinal cross-sectional view of a state of the sample container 150 at the time of operation of the rotor 130 of the conventional example.

### DESCRIPTIONS OF THE PREFERRED EMBODIMENTS

### First Example

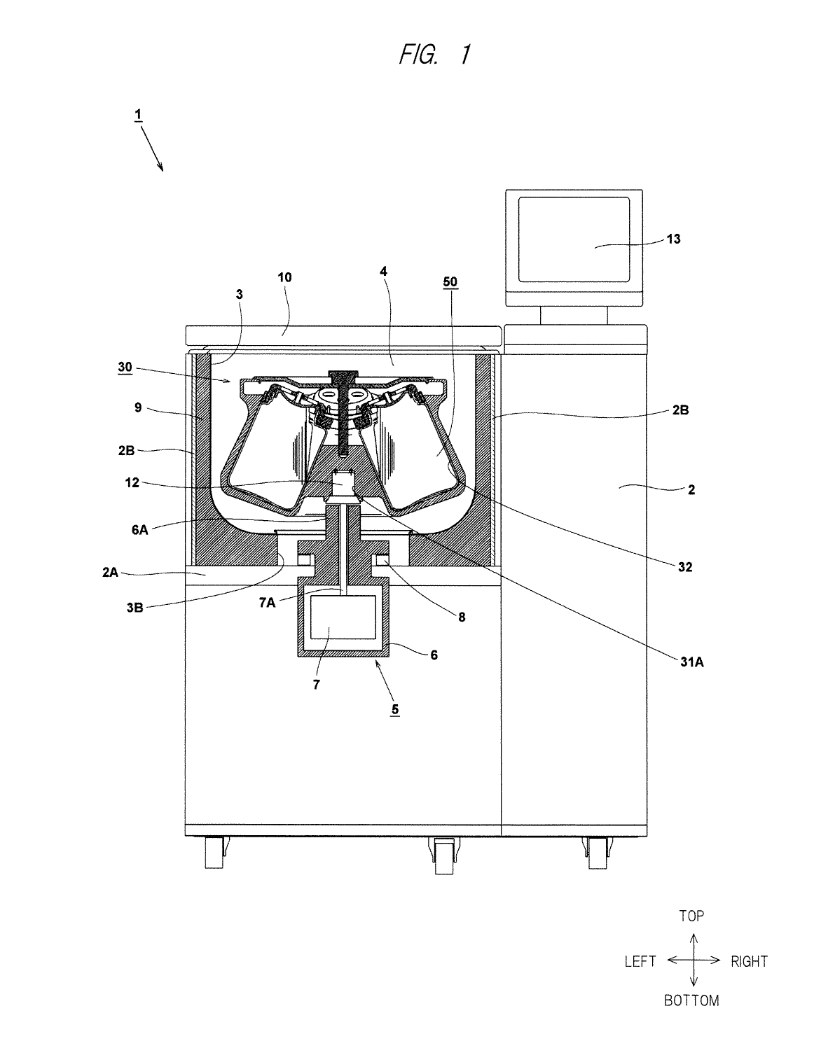

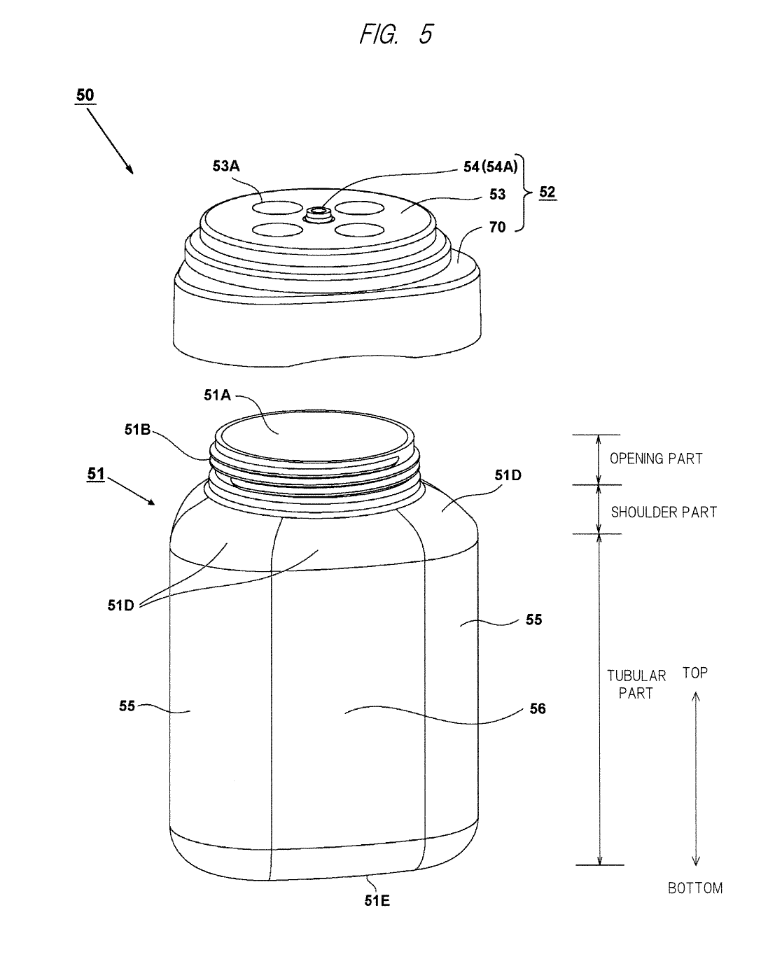

Hereinafter, a first embodiment of the present invention will be described based on the drawings. Note in the drawings described below that the same portions are provided with the same reference numeral, and repetitive descriptions will omitted. Also, it is assumed in the specification that vertical and horizontal directions of a centrifuge are those indicated in FIG. 1 and a vertical direction of a single sample container is a direction indicated in FIG. 5.

FIG. 1 is a front view of a centrifuge (a centrifugal machine) of the present invention, with its part illustrated in a cross-sectional view. The centrifuge 1 includes a rectangular-box-shaped casing 2 having an inside space partitioned by a horizontal partition plate 2A into two stages, upper and lower. The upper-stage space obtained by partitioning is provided with a bowl-shaped chamber 3 having its upper surface open. Around the outer circumference of the chamber 3, a coolant circulation pipe not shown is adhered. With a coolant supplied from a cooler not shown and provided inside the centrifuge 1 let flow through the coolant circulation pipe, the inner space of the chamber 3, that is, a rotor chamber 4, is cooled. On a periphery of the chamber 3, a heat insulator 9 and a protective barrier 2B are provided. A door 10 that can be opened and closed is provided on an upper side of the chamber 3. With the door 10 closed, the rotor chamber 4 is sealed. In this rotor chamber 4, a rotor 30 is accommodated. An operation and display part 13 is provided on an upper right side of the casing 2.

The lower stage obtained by partitioning with the partition plate 2A inside the casing 2 is provided with a driving part 5, which is mounted on the partition plate 2A. The riving part 5 has a motor housing 6, and an electric motor 7 is provided inside the motor housing 6 as a driving source. The motor housing 6 is fixed to the partition plate 2A via a damper 8. A shaft case 6A is provided on an upper side of the motor housing 6, and is arranged inside the rotor chamber 4 as penetrating through a hole 3B provided on the bottom of the chamber 3. The motor 7 has a rotating shaft 7A arranged so as to penetrate through the inside of the shaft case 6A, extending upward to the inside of the rotor chamber 4. A fitting part 12 is provided at an upper end of the rotating shaft 7A. The fitting part 12 is set in a fitting hole 31A of the rotor 30. The rotor 30 is configured so as to be attachable to and removable from the fitting part (driving shaft part) 12, and the rotor 30 is rotated by the motor 7. Normally, an operator selects and mounts the rotor 30 having holding holes in accordance with sample containers 50 for use. In each sample-container holding hole 32 formed in the rotor 30, the sample container 50 filled with a sample (a liquid sample) is inserted.

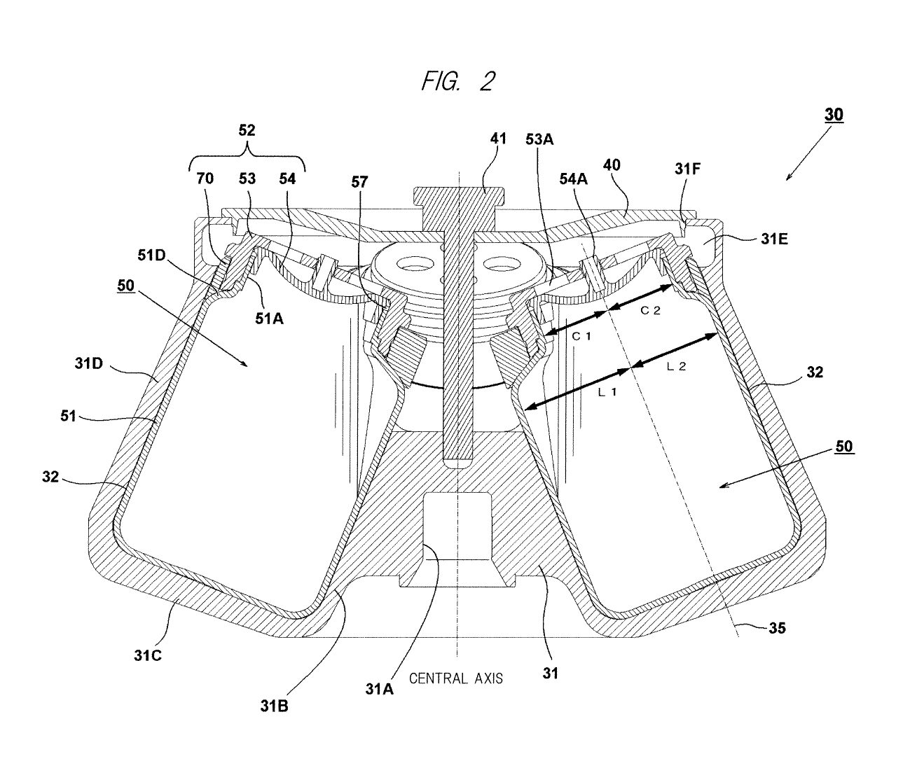

FIG. 2 is a longitudinal cross-sectional view of the rotor 30 of FIG. 1. The rotor 30 is mainly configured of a rotor body 31 substantially in a cone shape and a circular rotor cover 40 mounted thereon. In the rotor body 31, a plurality of the holding holes 32 for sample containers are formed with equiangular pitches along the circumference of a circle. Into each of the holding holes 32, the sample container 50 filled with the liquid sample is inserted. A liquid-sealing annular groove 31E is provided on the upper side of the rotor 30 to prevent liquid leakage from the rotor 30 in case of liquid leakage from the sample container 50 during centrifuging. An opening 31F is formed above the liquid-sealing annular groove 31E. The rotor cover 40 is mounted on the opening 31F. When a handle 41 is screwed to the rotor body 31, the rotor cover 40 is fixed to the rotor body 31. In this manner, the sample holding space of the rotor 30 is sealed. A fitting hole 31A is formed at a lower part of the center axis of the rotor body 31 for insertion of the rotating shaft 7A of the motor 7 (refer to FIG. 1). It is important for the fitting hole 31A to be fixed so as not to be rotatable relative to the fitting part 12, and insertion can be made by using a fixing method known in the field of centrifuges. According to this inserting method, the rotor 30 is driven by the motor 7 for rotation at a predetermined speed.

The sample container 50 has a circular opening 51A at the top, and a cap part 52 is mounted on the opening 51A. The cap part 52 of the present embodiment is mainly configured of a lid part (an outer lid 53 and an inner lid 54) and a neck support member 70 attachable to and removable from the lid part. When the lid part (the outer lid 53) is screwed to the body part 51, the opening 51A is sealed. A feature of the present embodiment is that a distance L1 from a center line 35 in the vertical direction of the sample container 50 to a side wall on an inner circumferential side of the container in a perpendicular direction is significantly larger than a distance L2 from the center line 35 to a side wall on an outer circumferential side of the container (L1>L2). On the other hand, at the opening 51A, a distance C1 from the center line 35 to an inner side of the opening and a distance C2 from the center line 35 to an outer side thereof are equal (C1=C2). It is assumed that these distances L1, L2, C1, and C2 are measured from the center line 35 in the perpendicular direction. The center line 35 is a virtual line passing through the center position (or a barycenter) of a bottom surface of the sample container 50 and the center position of the outer lid 53 (or the center of the opening 51A), and the center line 35 and the upper surface of the outer lid 53 have a perpendicular positional relation.

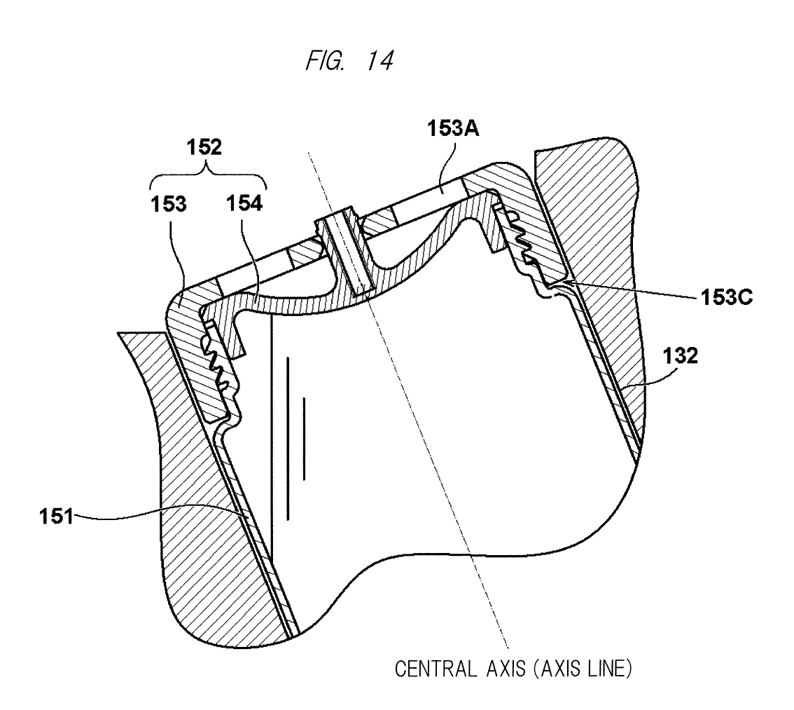

The neck support member 70 is a member interposed to fill a space between the outer lid 53 and an outer circumferential side wall part 31D of the rotor body 31. When the neck support member 70 is interposed between the outer lid 53 and the outer circumferential side wall part 31D, the relatively heavy outer lid 53 can be inhibited from moving to outside by a centrifugal force, thereby effectively preventing an excessive force from acting on the opening 51A and a shoulder part 51D. In the present embodiment, the lid part is implemented by the outer lid 53 and the inner lid 54 to achieve excellent sealing performance. Between a flange part extending in a radial direction of the inner lid 54 and an upper-end annular plane of the opening 51A, an O-ring 57 as a sealing member is interposed, thereby more enhancing sealing performance. On an upper part of the outer lid 53, a plurality of through holes 53A for removal are formed so as to penetrate through a space portion formed by fixing a projection 54A of the inner lid 54 to the outer lid 53. With this shape, a space in the cap can be ensured between the outer lid 53 and the inner lid 54. This space is formed such that the nearer the center of the outer lid 53, the wider a gap between the outer lid 53 and the inner lid 54. As the inner lid 54, a member identical to the inner lid 154 (refer to FIG. 14) used in a conventional example can be directly used.

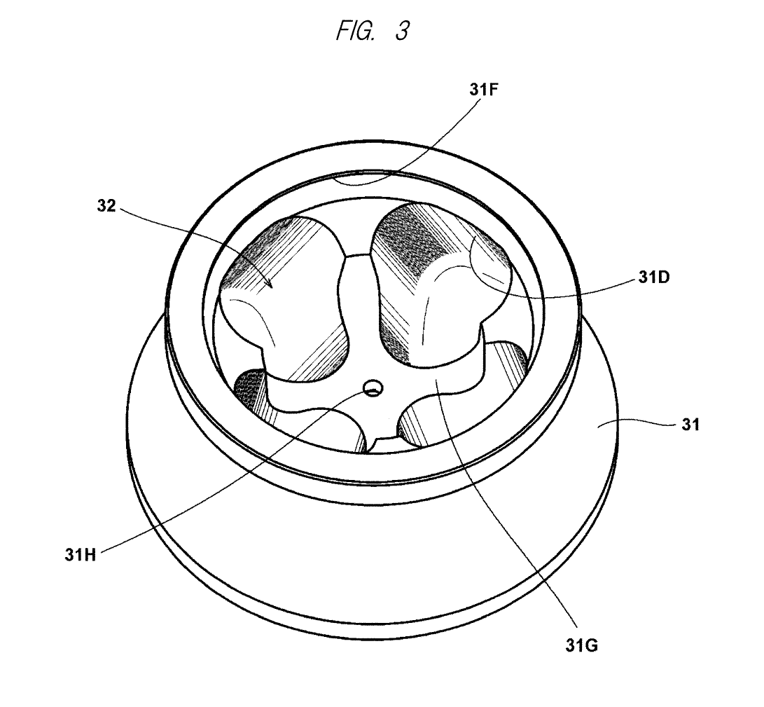

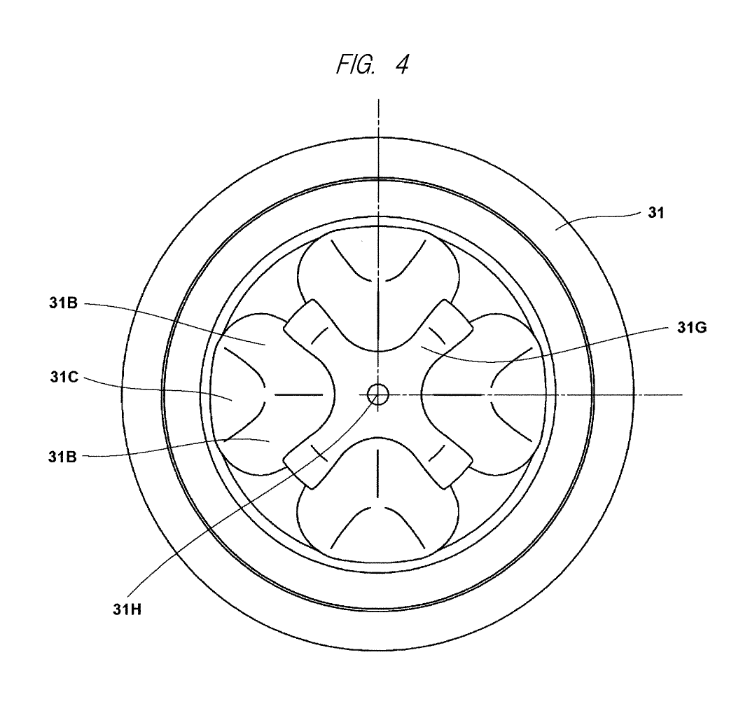

Next, the shape of the rotor body 31 will be described with reference to FIGS. 3 and 4. FIG. 3 is a perspective view of the rotor body 31 according to the first embodiment of the present invention, and FIG. 4 is a top view of the rotor body 31. The rotor body 31 is provided with four non-cylindrical holding holes 32 for mounting the sample containers 50. Each holding hole 32 has a shape substantially identical to the outer shape of the sample container 50, and has a size allowing the sample container 50 to be attached and removed without difficulty. Furthermore, a gap between the holding hole 32 and the sample container 50 is set as minimum as possible. The holding hole 32 is formed mainly of four faces, that is, the bottom part 31C and two inner circumferential side wall parts 31B illustrated in FIG. 4 (where a bottom part 51E and two side parts of the sample container 50 mainly abut) and the outer circumferential side wall part 31D illustrated in FIG. 3 (where one side part 56 of the sample container 50 abut). The outer circumferential side wall part 31D is a curved surface with a large radius of curvature supporting the sample container 50, and this curved surface is substantially in parallel with an outer circumferential curved surface of the rotor body 31. By forming the rotor body 31 in this manner, an unwanted increase in thickness near the outer circumferential side wall part 31D due to a difference in radius of curvature can be inhibited, thereby reducing the weight of the rotor 30. The holding hole 32 is formed so that cover an substantially all surfaces and the bottom of the body part 51 except a portion near an upper side on the inner circumference as illustrated in FIG. 2. As such, by forming the portion to be covered as large as possible, the sample container 50 itself during centrifuging operation can be prevented from being deformed.

The rotor body 31 has a hollow part (a thinned part) 31G formed by hollowing the center part in a downward direction to reduce the weight of the rotor body 31 at an upper part of the center axis and to lower the barycenter. At the center of the rotor body 31, a screw hole 31H for fixing the rotor cover 40 by screwing the handle 41 is formed. The rotor body 31 has an integral structure (a solid type) manufactured by machining with the use of an aluminum alloy or titanium alloy material. The rotor body 31 can be manufactured of a CFRP composite material also.

FIG. 5 is a perspective view of the outer appearance of the sample container 50. FIG. 5 illustrates a state in which the cap part 52 is removed. In FIG. 5, the sample container 50 configures a sample container for a centrifuge in the present invention, and can be divided into the body part 51 and the cap part 52. The body part 51 is a container portion where a liquid sample to be centrifuged is accommodated, and is provided at its top with the circular opening 51A as a port for loading and unloading the liquid sample. On the outer circumferential side of the opening 51A, a male thread part 51B is formed. In the cap part 52, as its section is illustrated in FIG. 2, the O-ring 57 (refer to FIG. 2) for sealing the opening 51A of the sample container 50 is interposed. In FIG. 5, the O-ring 57 is not viewable. On the inner surface of the outer lid 53, a female thread part, which is screwed together with the male thread part 51B of the opening 51A of the body part 51, is formed, thereby allowing the outer lid 53 to be mounted on the body part 51. On the upper part of the outer lid 53, the plurality of through holes 53A for removal are formed so as to penetrate through a space portion formed by fixing the projection 54A of the inner lid 54 to the outer lid 53. This space is formed such that the closer to the center part of the outer lid 53, the wider the gap between the outer lid 53 and the inner lid 54. The gap has a depth dimension on the order of 3 mm to 10 mm so as to allow an adult to grab the outer lid 53 with his or her fingers. The outer lid 53 can be grabbed with the thumb and the index finger, optionally added with the middle finger, through the through holes 53A. In this manner, the sample container 50 inserted in the holding hole 32 of the rotor body 31 can be easily withdrawn. While the shape of each through hole 53A can be optional and the number of through holes 53A can be optional as long as the sample container 50 can be easily removed, a desirable size is such that the finger tip, in particular, the thumb, of an adult can enter, and each through hole 53A preferably has a diameter on the order of 20 mm. On a lower side of the outer lid 53, the neck support member 70 is mounted. The neck support member 70 is a supplemental member for preventing the sample container 50 from being broken due to deformation at the time of centrifugal operation, and will be described in detail further below.

The body part 51 of the sample container 50 forms a container with a cross sectional shape of a curved surface based on an equilateral triangle having a large radius of curvature (for example, R=179 mm) with each of the side parts 56 of the equilateral triangle mildly projecting outward and with three apex parts 55 of the equilateral triangle connected with curved surfaces each having a small radius of curvature (for example, R=37 mm). On a side lower than the male thread part 51B of the body part 51, the shoulder parts 51D for smooth connection to the apex parts 55 and the side parts 56 are formed. The shoulder parts 51D each have a substantially triangular-shaped (a rice-ball-shaped) contour of its outer edge when viewed from above, and a circular contour of its inner circumferential edge. As such, the outer position of the body unit 51 is outside of the outer position of the opening 51A in a radial direction, and the shoulder parts 51D each connect the outer position of the body part 51 from the outer position of the opening 51A.

The body part 51 of the sample container 5, the neck support member 70, and the inner lid 54 are each preferably manufactured using a thermoplastic material (high-polymer resin) such as polypropylene or polycarbonate. The body part 51 can be easily manufactured by a blow molding method or an injection blow molding method. The opening 51A has an inner radius of 37.5 mm and an outer radius of 42.5 mm. The neck support member 70 can be easily manufactured by an injection molding method. In this manner, by forming with a thermoplastic material (high-polymer resin), a sample container highly resistant to chemicals and easy to handle can be achieved. Also, the O-ring 57 is suitably made of rubber, and a commercially-available product can be used. The body part 51 may be configured to be transparent or may be configured to be colored so that the inside is not viewable. On the other hand, it is important to configure the outer lid 53 with a non-elastic material. In the present embodiment, the outer lid 53 is integrally molded with a metal, for example, is manufactured of an aluminum alloy. In the present embodiment, the outer lid 53 has a weight of 260 g, the neck support member 70 has a weight of 92 g, the inner lid 54 has a weight of 32 g, and the body part 51 has a weight of 200 g. Here, the weight of the outer lid 53 is larger than the weight of the body part 51. In this manner, by making the outer lid 53 heavier than the body part 51, a centrifugal load can be effectively exerted in a direction of fastening the inner lid 54 by a downward centrifugal force exerted on the outer lid 53. Also, the neck support member 70 is far lighter than the outer lid 53, and has a weight that is half of the weight of the body part 51 or smaller. Therefore, the centrifugal load of the neck support member 70 can be effectively prevented from being excessively exerted on the body part 51. The neck support member 70 can effectively distribute centrifugal loads in the radial and axial directions locally exerted on a portion near the opening 51A and the male thread part 51B while reducing the load on the body part 51.

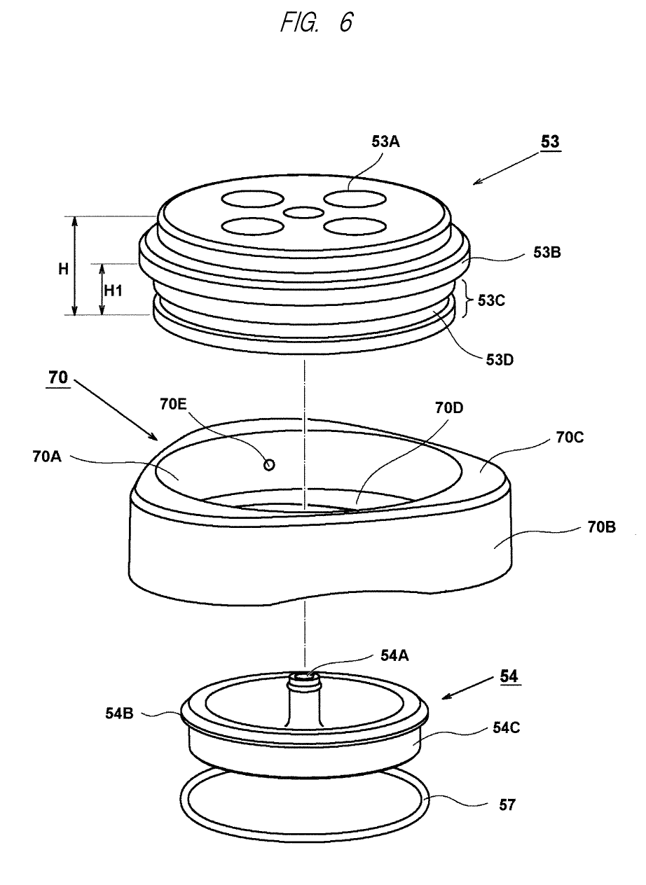

FIG. 6 is an exploded perspective view of the structure of the cap part 52 of the present embodiment. On an upper part of the outer circumferential part of the outer lid 53, a flange-like collar part 53B having a large diameter as compared with a lower part of the outer circumferential part is formed. On a lower side of the collar part 53B, a cylindrically-shaped cylindrical part 53C is formed. A step portion (a step part) between a lower surface (an annular flat portion) of the collar part 53B and the cylindrical part 53C can be in contact with an upper surface 70C of the neck support member 70, thereby achieving operation of pressing the neck support member 70. In this manner, the lower surface of the collar part 53B can be in contact with the neck support member 70. The collar part 53B is preferably positioned as high as possible in a vertical direction (in an axial direction). For example, when H denotes the height of the outer lid 53 and H1 denotes the height of the cylindrical part 53C, the step portion formed with the collar part 53B is preferably formed at a position upper than the center in the vertical direction, when H1 is half of H or higher. Also, a groove part 53D continuous in a circumferential direction is formed on the outer circumferential surface of the cylindrical part 53C of the outer lid 53 and near the center in the vertical direction. This groove part 53D is arranged at an engaging position without interfering with the projecting parts 70E provided on the inner circumferential part 70A of the neck support member 70, which will be described further below. In this manner, the neck support member 70 is held so as not to fall downward with respect to the outer lid 53, and the neck support member 70 and the outer lid 53 can be coupled together so as to relatively rotate in the circumferential direction. That is, when the outer lid 53 is removed from the body unit 51, the neck support member 70 is removed together with the outer lid 53.

The neck support member 70 has a circular hollow hole formed for letting the cylindrical part 53C of the outer lid 53 penetrate through. This hollow hole has an inner circumferential part (an inner circumferential surface) 70A formed therein. The inner circumferential part 70A has an inner diameter to an extent that a minimum gap is formed between the inner circumferential part 70A and the cylindrical part 53C. In this manner, the outer lid 53 can freely rotate with respect to the neck support member 70. Projecting parts 70E globularly projecting inside in a radial direction are formed at a plurality of positions along the circumferential direction of the inner circumferential part 70A, for example, at three positions at 120-degree pitches. The projecting parts 70E are formed at the time of integral molding of the neck support member 70. The neck support member 70 has an upper surface flatly formed so as to correspond to the lower surface (the step portion) of the collar part 53B. On the other hand, the neck support member 70 has a lower surface similar to the outer contour shape of the body part 51.

The shape of the inner lid 54 has the same shape of the inner lid 154 of the conventional example. The projection 54A is formed projecting upward near the center part of the inner lid 54. On the outer circumferential side of the inner lid 54, a cylindrical part 54C linked to an edge part 54B and therebelow is formed. The O-ring 57 is interposed so as to abut on an outer circumferential side of the cylindrical part 54C and a lower surface of the edge part 54B.

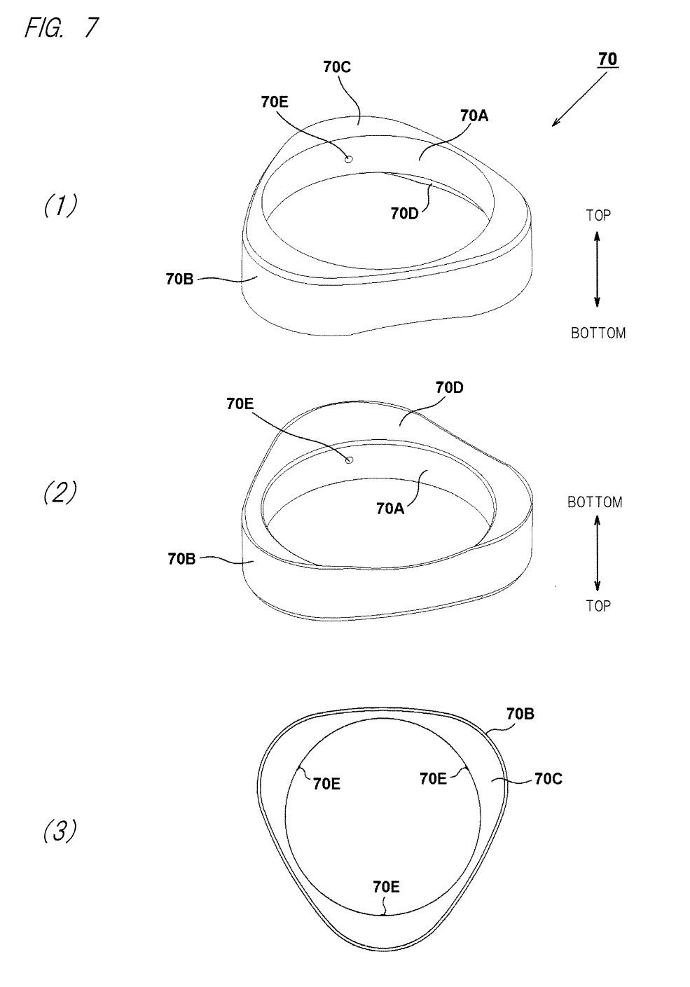

Next, the shape of the neck support member 70 alone will be described with reference to FIG. 7. FIG. 7 is a diagram of the shape of the neck support member 70 removed from the outer lid 53, in which (1) is a perspective view viewed from above, (2) is a perspective view viewed from bottom, and (3) is a top view. The neck support member 70 is set between the outer lid 53 of the sample container 50 and the holding hole 32, and is formed so that its outer shape fits to the inner wall of the holding hole 32 of the rotor body 31 and the gap between the neck support member 70 and the holding hole 32 is on the order of 0.1 mm to 1 mm. Inside the neck support member 70, a hollow hole (the inner circumferential part 70A) larger than the outer diameter of the cylindrical part 53C of the outer lid 53 by about 0.1 mm to 1 mm is formed. On a lower part of the neck support member 70, a recessed curved surface part 70D in a recessed shape substantially coinciding with the projecting curved surfaces of the shoulder parts of the sample container 50 are formed. Although it is difficult to understand the three-dimensional curved surface in (2) in FIG. 7, a substantially entire surface of the recessed curved surface part 70D abuts on the shoulder parts 51D at the time of centrifugal operation. The recessed curved surface part 70D is not necessarily formed as a complete surface, and a thinned part, a slit-like groove, or others required for integral molding may be formed as long as the centrifugal force transmitted from the recessed curved surface part 70D to the shoulder parts 51D is not locally concentrated.

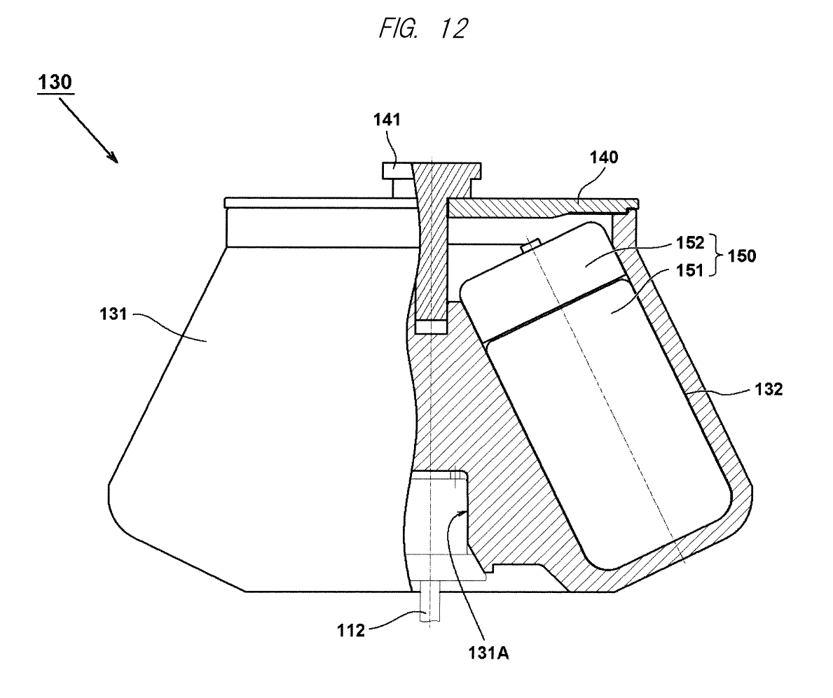

Effects of the respective components of the cap part 52 described so far are described. In the centrifuge 1, the rotor 30 rotates at a high speed, and a large centrifugal load is exerted on the cap part 52. In the centrifuge 1 of the present embodiment, the outer circumference of the outer lid 53 and the outer circumferential side wall part 31D of the rotor body 31 are separated away from each other and, furthermore, a portion for holding the outer circumferential side of the outer lid 53 is not present. Therefore, a portion near the opening 51A of the body part 51 and the shoulder parts 51D may be broken by the centrifugal load of the cap part 52. This phenomenon cannot occur in the case of the conventional cylindrical sample container 150 illustrated in FIG. 12 because the body part 151 and the lid 152 has the same outer shape and therefore the outer circumferential side of the lid 152 can be directly held by the wall surface of the holding hole 132. In the present embodiment, the neck support member 70 acting so as to fill the gap between the outer lid 53 and the holding hole 32 is added to support the outer circumferential part of the outer lid 53. That is, the structure is made such that the neck support member 70 minimizes the gap occurring between the outer circumferential part of the outer lid 53 and the outer circumferential side wall part 31D of the rotor body 31 and the cap part 52 is prevented from being deviated in the direction of the centrifugal force.

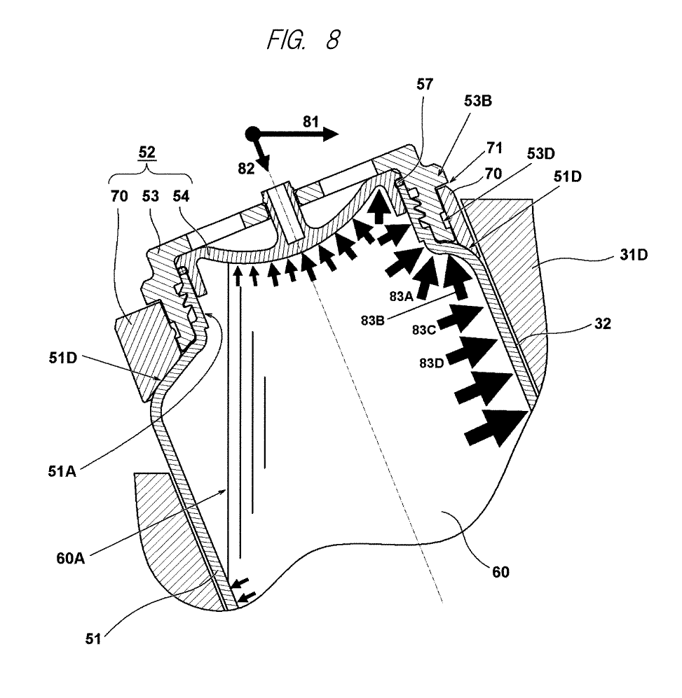

Next, effects of the collar part 53B of the outer lid 53 will be described. As illustrated in FIG. 8, when the rotor 30 is rotating at a high speed, a centrifugal force 81 indicated by an arrow is exerted. As a component force of this centrifugal force 81, a downward force 82 in the axial direction of the sample container 50 is exerted on the outer lid 53. This axially downward force 82 is loaded on the opening 51A downward in the axial direction of the sample container 50. Therefore, since the outer lid 53 is pressed downward if the outer lid 53 does not have the collar part 53B, the opening 51A may be slightly deformed downward. However, in the arrangement of the present embodiment, the collar part 53B is formed on the outer circumferential part of the outer lid 53 and, when the axially downward force 82 becomes strong, the lower flat surface portion (the annular flat part) of the collar part 53B can be in contact with the upper surface 70C of the neck support member 70 (refer to FIG. 7). With this structure, the axially downward force 82 of the outer lid 53 is partially transmitted to the neck support member 70 via the collar part 53B. Since the lower surface of the neck support member 70 is held by the shoulder parts 51D of the body part 51, the centrifugal force to be exerted on the outer lid 53 is distributed to the shoulder parts 51D via the neck support member 70 without being concentrated on a portion near the opening 51A. In FIG. 8, as indicated by an arrow 71, there is a slight gap between the lower surface of the collar part 53B and the upper surface 70C of the neck support member 70. Since the gap is illustrated in the drawing for the purpose of easy understanding, the gap seems to be large, but in practice, it is sufficient that the gap is minimum so as to allow rotation without inhibition by the neck support member 70 against the outer lid 53. Also, it poses no problem even when a holding state is such that the lower surface of the collar part 53B and the neck support member 70 are in contact with each other when at rest, and any position relation is possible as long as the lower surface of the collar part 53B and the neck support member 70 are in good contact with each other when the axially downward force 82 is increased at the time of centrifuging.

Next, effects brought by the collar part 53B will also be described. As indicated by bold arrows in FIG. 8, a fluid pressure is loaded on the body part 51 of the sample container 50 from inside toward outside during centrifugal operation. A liquid level 60A of a sample 60 in the sample container 50 becomes extending in the vertical direction (parallel to a rotating axis) due to the centrifugal force 81. Near one of the shoulder parts 51D of the body part 51, a strong fluid pressure is loaded from inside toward outside as indicated by arrows 83A to 83D. This is due to the sample 60 during centrifugal operation, and a stronger fluid pressure is exerted on a portion with a larger radius of gyration. In the present embodiment, a particularly strong fluid pressure is exerted on the shoulder part 51D positioned outside during centrifugal operation. As indicated by the arrows 83A and 83B, the body part 51 may be expanded upward by an axially upward force. While this deformation can be inhibited to some extent by pressing the shoulder part 51D axially downward by the neck support member 70, the axially downward force 82 due to the centrifugal force of the outer lid 53 described above is added to the neck support member 70 via the collar part 53B, and therefore this can further reliably prevent deformation of the shoulder part 51D.

As described above, in the sample container 50 with the non-cylindrical outer shape, the neck support member 70 is an important component. However, since the neck support member 70 is configured of a component different from the outer lid 53 and the body part 51, the operator may possibly start operation of the centrifuge 1 forgetting about mounting the neck support member 70. To prevent this, the neck support member 70 has to be configured such that it is difficult to forget about mounting the neck support member 70. For example, ideally, the outer lid 53 and the neck support member 70 are configured to be integrally molded to be relatively fixed to each other. However, the shapes of the shoulder parts of the body part 51 are not rotationally symmetrical to each other, the cap part 52 and the body part 51 cannot be fastened by being screwed. This is because the space between the outer lid 53 and the outer circumferential side wall part 31D of the rotor body 31 is not in an axially symmetric shape. For this reason, a gap may occur between the outer shape of the cap part 52 and the outer shape of the body part 51 depending on the fastening condition, and the cap part 52 and the body part 51 may interfere with each other before fastening is completed. Therefore, the outer lid 53 and the neck support member 70 have to be mutually not fixed to each other, while having the structure preventing the neck support member 70 from being forgotten to be mounted. The following structure has been invented by the inventors to solve this problem.

Before the cap unit 52 is mounted on the body part 51, the neck support member 70 is engaged with the outer lid 53 so as to be capable of relative rotation. Here, since the outer circumferential part of the cylindrical part 53C of the outer lid 53 and the projecting parts 70E of the neck support member 70 projecting inside slightly interfere with each other, the neck support member 70 is forcibly fitted by using a method such as press fitting. In this manner, the projecting parts 70E are engaged as being inserted in the groove part 53D formed on the cap part 52. The degree of interference between the cylindrical part 53C and the projecting parts 70E is arbitrarily determined depending on the shape and dimensions of the projecting parts 70E at the time of manufacture. The projecting parts 70E of the neck support member 70 may be arranged at any positions as long as they do not interfere with the groove part 53D at the time of completion of engagement, and the shape, dimensions, and the number of projecting parts 70E of the neck support member 70 may be optional as long as no interference occurs. Since the groove part 53D is continuously provided so as to be axially symmetrical with respect to the center axis of the outer lid 53, the outer lid 53 and the neck support member 70 can mutually slide freely in the circumferential direction.

If the outer lid 53 and the neck support member 70 are engaged with each other before the outer lid 53 is mounted in the body part 51, they are not separated unless the operator intends to do so. Therefore, the neck support member 70 is not forgotten to be mounted when the centrifuge is operated. On the other hand, if the outer lid 53 and the neck support member 70 have to be separated for the purpose of cleaning, replacement, or others, they can be forcibly separated from each other by a procedure obtained by reversing an assembling procedure.

The cap part 52 having the outer lid 53 and the neck support member 70 is inserted in the body part 51 with a screw structure. Here, the shoulder parts 51D of the body part 51 and the recessed curved surface part 70D of the neck support member 70 have to coincide with each other at the time of mounting. Since the sample container 50 has a substantially triangular outer shape, the shoulder parts 51D can take contours axially asymmetrical to the center axis of the body part 51. When the recessed curved surface part 70D is made to coincide with the shoulder parts 51D, the neck support member 70 is inevitably fixed to the body part 51 in the circumferential direction. Here, since the outer lid 53 and the neck support member 70 can mutually slide freely in the circumferential direction, even if the neck support member 70 is relatively fixed to the body part 51, no problem occurs to attachment and removal of the outer lid 53 by screwing.

While description has been made based on the first embodiment of the present invention, various modifications can be made. For example, while the lid part has been manufactured so as to have a double structure of an outer lid and an inner lid, the lid part may be manufactured as an integral lid part. Also, while the present invention is particularly effective when the shape of the sample container is not cylindrical, the shape of the outer contour of the sample container when viewed from above is not restricted to a substantially triangular shape, and the present invention can be similarly used to another non-circular container (however, its opening has a circular shape). Furthermore, even if the sample container has an existing cylindrical shape, the present invention can be similarly used if the outer shape of the lid part and the outer shape of the body part are different from each other in the container.

### Second Example

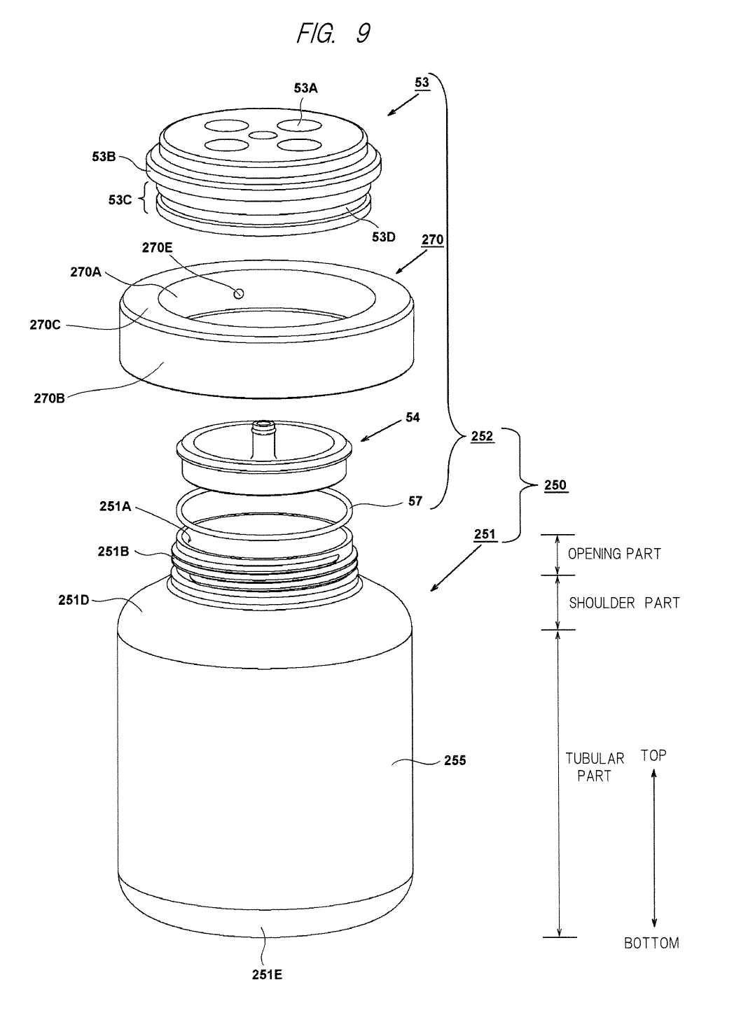

Next, a second embodiment of the present invention will be described with reference to FIGS. 9 to 11. In the second embodiment, a sample container has a cylindrical sectional shape, and the container has a smaller opening of a lid part compared with the outer shape of a main body portion of the container. In this sample container, a cap part having a neck support member is used. This structure is to achieve, by using the cap unit having the neck support member that has been used also in the first embodiment in the cylindrical sample container, a further increase in capacity compared with the conventional sample container and a further increase in centrifugal speed by using an operation of holding the opening by the neck support member.

FIG. 9 is a perspective view of the outer appearance of a sample container (a sample container for a centrifuge) 250 of the second embodiment of the present invention. The sample container 250 is configured of a body part 251 and a cap part 252, and FIG. 9 illustrates a state in which the cap part 252 has been disassembled. The body part 251 is a container in which a sample to be centrifuged is accommodated, and is provided at its top with a circular opening 251A as a port for loading and unloading the sample. On the outer circumferential side of the opening 251A, a male thread part 251B is formed. In the cap part 252, the outer lid 53, the inner lid 54, and the O-ring 57 described in the first embodiment are used in the same manner, and replacement is made by a neck support member 270 having a shape corresponding to the body part 251. It is important for the outer lid 53 to have a weight to some extent so as to exert a centrifugal load in a downward direction on the center axis of the container (in a direction oriented from the opening to the bottom) at the time of centrifuging to press the neck support member 270. Therefore, the outer lid 53 is made of a metal such as an aluminum alloy. On the other hand, an upper surface side of the neck support member 270 is pressed by the flange-shaped collar part 53B of the outer lid 53. This pressing force acts as pressing entire shoulder parts 251D of the body part 251 and also acts as stably folding the outer lid. They are main preferred aims. Therefore, it is important to manufacture the neck support member 270 lighter in weight compared with the outer lid 53. For example, if the neck support member 270 is also made of a metal, the entire weight of the cap part 252 is too increased, increasing too much the centrifugal force exerted in a downward direction (a direction from the opening toward the bottom) on the center axis of the body part 251 from the cap part 252 at the time of rotation. For this reason, the neck support member is integrally molded with synthetic resin such as plastic in the present embodiment.

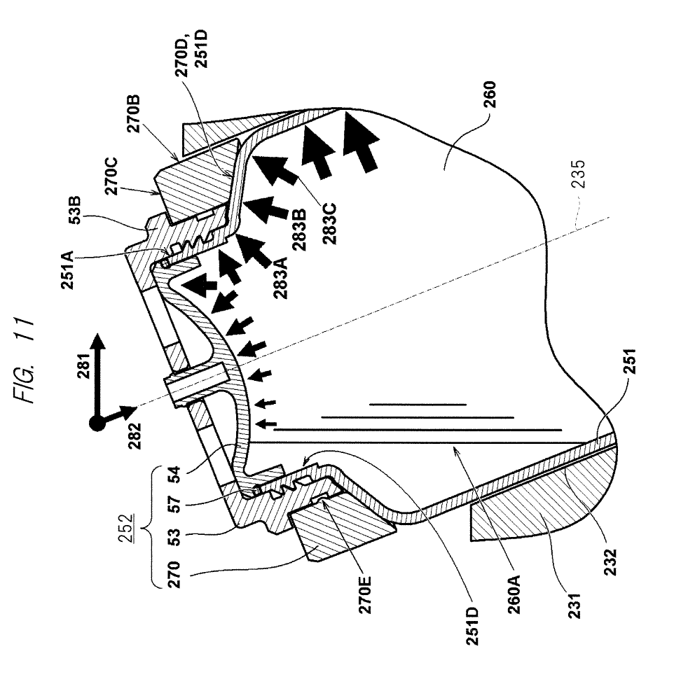

The neck support member 270 has a circular hollow hole formed for letting the cylindrical part 53C of the outer lid 53 penetrate through. A counter part of the hollow hole serves as an inner circumferential part 270A. The inner circumferential part 270A has an inner diameter so that a minimum gap is formed between the inner circumferential part 270A and the cylindrical part 53C, and the neck support member 270 can be attached to and removed from the cylindrical part 53C. Projecting parts 270E semispherically projecting inside in a radial direction are formed at a plurality of positions of the inner circumferential part 270A, for example, at three positions at 120-degree pitches. This is to reuse the outer lid 53 of the first embodiment. If the outer lid 53 of the first embodiment is not reused and a cap part for the body part 251 is manufactured, a mounting method may be taken in which the neck support member 270 is firmly fixed so as not to be able to make relative rotation with respect to the outer lid 53. Also, by utilizing the fact that relative rotation is unnecessary at the time of mounting, the outer lid and the neck support member may be configured by integral molding of a light metal such as titanium or resin. The projecting parts 270E are formed at the time of integral molding of the neck support member 270, are arranged so as to be engaged without interference with the groove part 53D continuous in the circumferential direction and formed on the outer circumferential surface of the outer lid 53. The neck support member 270 has an upper surface flatly formed so as to correspond to the lower surface (the step portion) of the collar part 53B. As such, the neck support member 270 is held so as not to fall downward with respect to the outer lid 53, and is coupled in the circumferential direction so that the neck support member 270 and the outer lid 53 can relatively rotate. The neck support member 270 has a lower surface similar to the outer contour shape of the body part 251 and, in particular, is formed so as to be in good contact with the shoulder parts 251D. The outer circumferential surface 270B of the neck support member 270 has a circular outer shape and a circular inner shape of a section perpendicular to the center line (a reference numeral 235 of FIG. 11, which will be described further below) of the container. The outer dimensions of the neck support member 270 are substantially equal to the outer dimensions of the body part 251 and are also substantially equal to the inner dimensions of the holding hole 232 of the rotor body 231.

The body part 251 of the sample container 250 forms a container having a circular cross sectional shape and, as with the sample container 150 illustrated in FIG. 12, has a cylindrically-shaped body part. That is, the body part 251 has a circular outer shape viewed from above. However, the body part 251 is configured to have a shape with its outer shape further increased while the size of the opening of FIG. 12 is kept unchanged. Here, if the entire size is further increased while the shape of FIG. 12 is kept unchanged, the outer diameter of the lid 152 is also increased, thereby posing a problem in which it is difficult for the operator to open and close the lid 152 by grabbing the lid 152 by hand. To address the problem, in the second embodiment, the sample container 250 is configured to have a shape with only the outer shape of the body part 251 being thickened while the diameter of the opening 251A of the body part 251 is kept to one substantially the same as the first embodiment. On a side lower than the male thread part 251B of the body part 251, a shoulder part 251D for connecting the cylindrical part 255 to the opening 251A is formed. The shoulder part 251D has a shape such that a smooth curvature is drawn for achieving easy molding and advantage in strength. In the present embodiment, the body part 251 has an outer diameter of 133 mm, and the opening 251A has a radius of an inner diameter of 37.5 mm and a radius of an outer diameter of 42.5 mm. Also, the neck support member 270 has an outer diameter of 133 mm. That is, the neck support member 270 has a circular outer shape with a diameter equal to a diameter of the body part 251 when viewed from above. The body part 251 has a length in an axial direction of 172 mm in total, with a cylindrical part having a length of 135 mm, a shoulder part having a length of 15 mm, and an opening having a length of 23 mm. However, this total length can be set as appropriate according to the size of the rotor for use. By setting the size in this manner, the sample container 250 having a capacity of a 1,000-ml class or larger can be achieved.

In the same manner as the first embodiment, the body part 251 of the sample container 250, the neck support member 270, and the inner lid 54 are each preferably manufactured of a thermoplastic material such as polypropylene or polycarbonate. As such, the outer lid 53 is configured of a member with a large specific gravity in weight, the neck support member 270 is configured of a member with a small weight, and the cap part 252 is mainly configured of two components with different weights. Therefore, the cap part 252 in the sample container having a relatively large capacity of 500 ml or larger can be relatively light in weight. According to calculations by the inventors, it has been found that when a 230-ml-capacity and metal-cap-equipped sample container for a high-speed rotor of a category different from the model covered by the present invention is increased in shape to scale up the capacity to 1000 ml, the weight of the cap part is increased from 96 g to an impractical weight, that is 460 g. However, if only the outer lid 53 is made of a metal and the neck support member 270 is resinified as in the present embodiment, the entire weight except for the inner lid 54, that is, the total mass of the outer lid 53 and the neck support member 270, is 360 g, which is light and under 400 g. In this manner, in the second embodiment, while an increase in weight of the cap part is effectively prevented, an excessive centrifugal load can be prevented from being exerted on the opening 251A by interposing the neck support member 270. Therefore, a further increase in capacity of the sample container than ever and an increase in rotation of the rotor can be achieved.

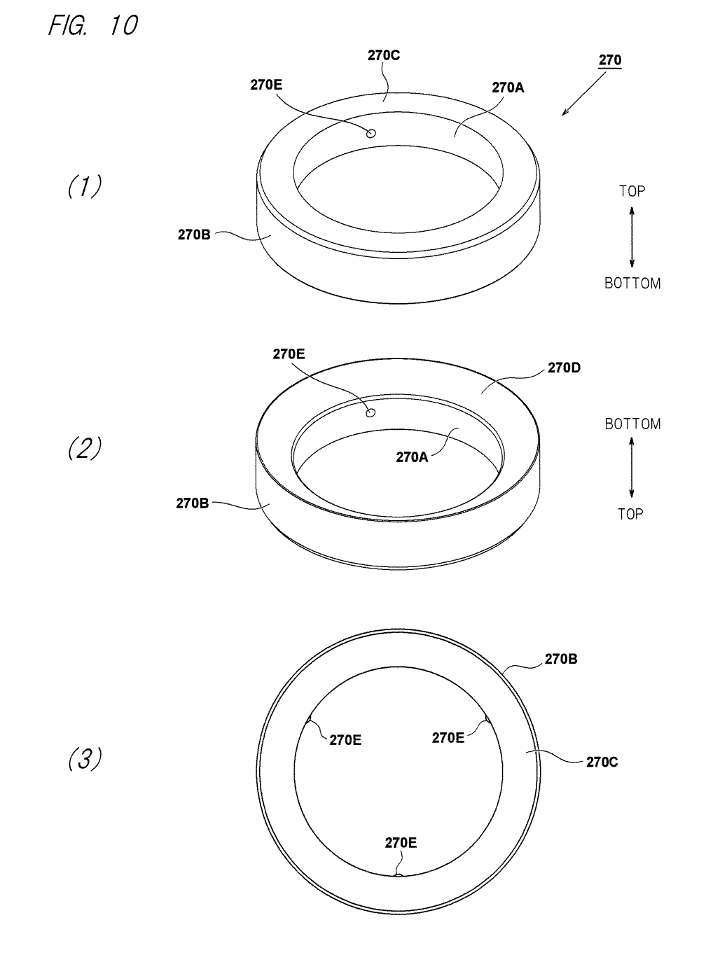

Next, the shape of the neck support member 270 alone will be described with reference to FIG. 10. FIG. 10 is a diagram of the shape of the neck support member 270 removed from the outer lid 53, in which (1) is a perspective view viewed from above, (2) is a perspective view viewed from bottom, and (3) is a top view. The neck support member 270 is set between the outer lid 53 of the sample container 250 and the inner wall of the holding hole 232 when viewed in the radial direction and between the collar part 53B of the outer lid 53 and the shoulder part 251D of the body part 251 when viewed in the vertical direction (the axial direction). Having the outer shape of the sample container 250 fitting to the inner wall of the holding hole 232 of the rotor body 231, a gap between the outer lid 53 and the holding hole 232 is formed so as to be sufficiently small on the order of 0.1 mm to 1 mm. As with the first embodiment, the size of this gap is preferably on the order of a minimum gap allowing the sample container 250 to be smoothly attached to and removed from the holding hole 232 of the rotor body 231 so as to achieve a rattle-free state. Inside the neck support member 270, a hollow hole (the inner circumferential part 270A) larger than the outer diameter of the cylindrical part 53C of the outer lid 53 by about 0.1 mm to 1 mm is formed. Unlike the first embodiment, the size of this gap may be slightly tight. The reason for this is that while relative rotation of the outer lid 53 and the neck support member 70 is imperative in the first embodiment, no problem occurs irrespectively of relative rotation of the outer lid 53 and the neck support member 270 in the second embodiment. On a lower part of the neck support member 270, a recessed curved surface part 270D in a recessed shape substantially coinciding with a curved surface of the shoulder part 251D of the sample container 250 is formed. Although it is hard to understand the three-dimensional curved surface in (2) in FIG. 10, an substantially entire surface of the recessed curved surface part 270D is configured to abut on the upper surface of the shoulder part 251D at the time of centrifugal operation. The recessed curved surface part 270D is not required to be formed as a complete continuous surface, and may be a surface (an intermittent surface) substantially continuous to an extent that the centrifugal force transmitted from the recessed curved surface part 270D to the shoulder part 251D is not locally concentrated.

When the rotor body 231 rotates at a high speed, a centrifugal load is exerted on the cap part 252. Since the neck support member 270 for supporting the outer circumference of the outer lid 53 is added to the outer lid 53 of the present embodiment, the cap part 252 can be prevented from being displaced to a centrifugal force direction. This effect is illustrated in FIG. 11. As illustrated in FIG. 11, as a component force of a centrifugal force 281, a downward force 282 in the axial direction of the sample container 250 is exerted on the outer lid 53. The axially downward force 282 is loaded on the opening 251A downward in the axial direction. Therefore, since the outer lid 53 is pressed downward if the outer lid 53 does not have the collar part 53B, the opening 251A may be slightly deformed downward.

However, in the present embodiment, the collar part 53B is formed on the outer circumferential part of the outer lid 53 and, when the axially downward force 282 becomes strong, the lower flat surface portion (the annular flat part) of the collar part 53B can be in contact with an upper surface 270C of the neck support member 270 (refer to FIG. 10). In this manner, the axially downward force 282 is partially transmitted to the neck support member 270 via the collar part 53B. Since the lower surface of the neck support member 270 is held by the shoulder part 251D of the body part 251, the centrifugal force to be exerted on the outer lid 53 is distributed to the entire shoulder part 251D via the neck support member 270 without being concentrated on a portion near the opening 251A. While FIG. 11 illustrates that there is a slight gap between the lower surface of the collar part 53B and the upper surface 270C of the neck support member 270, this gap may be almost zero.

During centrifugal operation, as indicated by bold arrows in the drawing, a fluid pressure is loaded on the body part 251 from inside toward outside. A liquid level 260A of a sample 260 in the sample container 250 becomes extending in the vertical direction (parallel to a rotating axis) due to the centrifugal force 281. Near the shoulder part 251D of the body part 251, a strong fluid pressure is applied from inside toward outside as indicated by arrows 283A to 283C. This is due to the sample 260 during centrifugal operation, and a stronger fluid pressure is exerted on a portion with a larger radius of gyration. A particularly strong fluid pressure is exerted on the shoulder part 251D positioned outside during centrifugal operation. As indicated by the arrows 283A to 283C, the body part 251 may be expanded upward by an axially upward force. While this deformation can be inhibited to some extent by pressing the shoulder part 251D axially downward by the neck support member 270, the axially downward force 282 due to the centrifugal force of the outer lid 53 described above is added to the neck support member 270 via the collar part 53B, and therefore this can further reliably prevent deformation of the shoulder part 251D.

As described in the foregoing, according to the second embodiment, only by replacing the neck support member 70 used in the first embodiment by the neck support member 270 for the cylindrically-shaped body part 251, the neck support member 270 can be used as the cap part 252 for the body part 251. Here, since the inner lid 54 and the O-ring 57 of the first embodiment can be used as they are, shared components can be increased to reduce manufacturing cost. Also, since the neck support member 270 is made attachable to and removable from the outer lid 53, the cap part 252 can be easily cleaned. Furthermore, while the cap part is formed of the outer lid formed of a material with a large specific gravity and the neck support member formed of a material with a small specific gravity in the first and second embodiments, they can be manufactured by integral molding when the body part 251 is a cylindrically-shaped bottle. However, if the neck support member 270 and the outer lid 53 are both made of a metal to increase the capacity to 500 ml or more, the weight of the entire cap part is too heavy compared with the size of the body part 251 and the opening 251A, and therefore the axially downward force 282 exerted on the body part 251 becomes too excessive. Moreover, since the weight of the entire sample container 250 becomes heavy, the load on a rotor body 231 side is increased, which is not preferable. Therefore, when the outer lid and the neck support member are integrally configured, the present invention is preferably restricted to be applied to a sample container with a small capacity smaller than 500 ml or/and a sample container for a low-speed rotor with a maximum permissive number of revolution equal to or smaller than 10000 rpm.

While the present invention has been described above based on the embodiments, the present invention is not restricted by the embodiments described above, and can be variously modified within a range not deviating from the gist of the present invention. For example, while the body parts 51 and 251 are made of a synthetic resin in the first and second embodiments, the body part may be made of a metal.

Hereinafter, sample containers for centrifuges of embodiments and effects obtained from each embodiment will be described.

In a sample container for a centrifuge of an embodiment, the outer circumference of the neck support member is has a shape substantially identical to the body part when viewed from above. When the outer lid is mounted on the body part, the neck support member is arranged so as to be interposed between the outer lid and the body part. Thus, the centrifugal force exerted on the outer lid can be effectively supported by the neck support member. Therefore, the sample container for the centrifuge can be prevented from being broken or degraded due to a centrifugal force.

In a sample container for a centrifuge of another embodiment, the outer lid has an outer circumference having a collar part, and the neck support member is interposed between the collar part and the body part. Thus, by only fastening the lid part, the neck support member can also be appropriately positioned in a good condition. By the collar part, the neck support member can be pressed.

In a sample container for a centrifuge of still another embodiment, the neck support member has a smaller specific gravity and a lighter weight compared with the outer lid. Thus, an influence of a centrifugal load on the body part due to installation of the neck support member can be reduced.

In a sample container for a centrifuge of still another embodiment, the neck support member has a non-circular outer shape identical to the shape of the body part when viewed from above. By mounting the lid part on the body part, the neck support member is interposed between the lid part and the body part. Thus, the centrifugal force exerted on the lid part can be supported also by the support part. Therefore, the sample container for the centrifuge can be prevented from being broken or degraded due to a centrifugal force.

In a sample container for a centrifuge of still another embodiment, the neck support member is interposed between the shoulder part and the lid part in the axial direction. Thus, a local load exerted on the opening from the lid part can be reduced.

In a sample container for a centrifuge of still another embodiment, the neck support member has a lower surface in the axial direction having a shape corresponding to the shoulder part, and has an upper surface in the axial direction formed in a flat shape perpendicular to the axial direction. Thus, the neck support member can be prevented from being broken due to a local load exerted on a partial portion of the neck support member.

In a sample container for a centrifuge of still another embodiment, the lid part has a flat surface part which abuts on the upper surface of the neck support member. Thus, the lid part and the body part can be freely attached and removed by a screw structure.

In a sample container for a centrifuge of still another embodiment, the neck support member is held by the lower surface of the step part provided on the lid part and the shoulder part. Thus, only by fastening the lid part, the neck support member can also be appropriately positioned in a good condition.

In a sample container for a centrifuge of still another embodiment, the step part is formed of a collar part projecting in a radial direction from an outer circumferential surface of the lid part. Thus, the collar part can form a holding part to be held by the operator, and also can form the step part for fixing the neck support member. Here, the step part is formed at an upper position than the center of the axial direction of the lid part. Thus, the gap between the lid part and the holding hole of the rotor can be filled at a half or more of the distance of the lid part in the axial direction, and an excellent support effect can be expected.

In a sample container for a centrifuge of still another embodiment, the lid is manufactured by integral molding of a metal. Thus, high strength and high durability can be achieved.

In a sample container for a centrifuge of still another embodiment, the lid part is heavier than plastic or others. Thus, at the time of centrifugal operation, with a centrifugal force, the lid part can have a pressing force with respect to the body part, and therefore deformation of the shoulder part can be reliably prevented via the neck support member.

In a sample container for a centrifuge of still another embodiment, the neck support member is engaged with and attachable to and removable from the lid part and is held so as to be able to relatively rotate with respect to the lid part. Thus, the lid part can be fastened with the neck support member mounted on the lid part. Therefore, a sample container that is easy to use can be achieved.

In a sample container for a centrifuge of still another embodiment, the lid part and the neck support member are held by the groove part extending in a circumferential direction and the projection. Thus, once assembled, they are not removed unless the operator intends to do so. For this reason, no concern is required about whether the neck support member is mounted, and the opening and its periphery of the sample container for the centrifuge can be prevented from being deformed or broken due to the centrifugal force.

In a sample container for a centrifuge of still another embodiment, the groove part is continuously formed in the circumferential direction. Thus, even if the neck support member engaged with the groove part is fixed in the circumferential direction, the lid part can be freely slid in the circumferential direction. Therefore, the lid part and the body part can be freely attached and removed by a screw structure.

Instill another embodiment, the rotor for the centrifuge has a plurality of holding holes for holding the sample containers for the centrifuge described above, and the centrifuge has a driving part for rotating this rotor for the centrifuge and a rotor chamber which accommodates the rotor. Therefore, it is possible to achieve a rotor for a centrifuge and a centrifuge capable of attaining more resistance to a centrifugal load than ever, a large capacity more than 1000 ml, and higher speed than those of conventional models.

What is claimed is:

1. A sample container for a centrifuge, comprising:
a body part capable of accommodating a sample;
an outer lid mountable on the body part; and
a neck support member provided on an outer circumferential side of the outer lid for filling a space between an outer circumferential surface of the outer lid and a holding hole of a rotor of the centrifuge,
the body part having a circular opening on top and the outer lid being attachable to and removable from the opening by screwing via a sealing member,
the neck support member having an outer circumference substantially identical in shape to the body part when viewed from above, and
the neck support member being arranged so as to be interposed between the outer lid and the body part when the outer lid is mounted on the body part.

2. The sample container for the centrifuge according to claim 1, wherein
the outer lid has a collar part on an outer circumference, and the neck support member is interposed between the collar part and the body part.

3. The sample container for the centrifuge according to claim 2, wherein
the neck support member has a specific gravity smaller than a specific gravity of the outer lid.

4. The sample container for the centrifuge according to claim 3, wherein
the neck support member has a weight lighter than a weight of the outer lid.

5. The sample container for the centrifuge according to claim 1, wherein
the outer lid is made of metal, and the neck support member is made of resin, and
when the outer lid is removed from the body part, the neck support member is removed together with the outer lid.

6. The sample container for the centrifuge according to claim 5, wherein
the body part has a shoulder part connecting an outer position of the body part from the opening,
the neck support member has a lower surface in an axial direction with a shape corresponding to the shoulder part, and
the neck support member is mounted so as to be interposed between the shoulder part and the outer lid in the axial direction.

7. The sample container for the centrifuge according to claim 1, wherein
the sample container for the centrifuge has a capacity larger than or equal to 1000 ml, and the opening has an inner diameter larger than or equal to 75 mm.

8. The sample container for the centrifuge according to claim 1, wherein
the sample container for the centrifuge has a capacity larger than or equal to 1000 ml and has a maximum permissive number of revolution larger than or equal to 10000 rpm, and a total mass of the outer lid and the neck support member is smaller than or equal to 400 g.

9. The sample container for the centrifuge according to claim 1, wherein
the body part has a non-circular outer shape when viewed from above, and
the neck support member has an outer shape identical to the outer shape of the body part when viewed from above, and is held by the outer lid so as to be able to relatively rotate with respect to the outer lid.

10. The sample container for the centrifuge according to claim 1, wherein
the body part has a circular outer shape when viewed from above, and
the neck support member has a circular outer shape having a diameter equal to a diameter of the body part when viewed from above.

11. A rotor for a centrifuge, the rotor having a plurality of holding holes for holding the sample container for the centrifuge according to claim 1.

12. A centrifuge comprising:
the sample container for the centrifuge according to claim 1;
a rotor having a plurality of holding holes for holding the sample container for the centrifuge;
a driving part for rotating the rotor; and
a rotor chamber for accommodating the rotor.

13. A sample container for a centrifuge, comprising:
a body part capable of accommodating a sample;
a lid part mountable on the body part;
a neck support member provided on an outer circumferential side of the lid part for filling a space between an outer circumferential surface of the lid part and a holding hole of a rotor of the centrifuge,
the body part having a non-circular outer shape when viewed from above and having a circular opening on top,
the lid part being attachable to and removable from the opening by screwing via a sealing member,
the neck support member having a non-circular outer shape identical to the shape of the body part when viewed from above, and
the neck support member being arranged so as to be interposed between the outer lid and the body part when the outer lid is mounted on the body part.

14. The sample container for the centrifuge according to claim 13, wherein
an outer position of a part or entirety of the body part is outside an outer position of the opening in a radial direction, and the body part has a shoulder part connecting the outer position of the body part from the outer position of the opening, and
the neck support member is interposed between the shoulder part and the lid part in an axial direction.

15. The sample container for the centrifuge according to claim 14, wherein
the neck support member has a lower surface in the axial direction having a shape corresponding to the shoulder part, and has an upper surface in the axial direction formed on a plane perpendicular to the axial direction.

16. The sample container for the centrifuge according to claim 15, wherein
the lid part has a flat surface part which abuts on the upper surface of the neck support member.

17. The sample container for the centrifuge according to claim 16, wherein
a step part forming the flat surface part is provided on an outer circumferential side of the lid part, and the neck support member is held by a lower surface of the step part and the shoulder part when the lid part is mounted.

18. The sample container for the centrifuge according to claim 17, wherein
the step part is formed of a collar part projecting in a radial direction from an outer circumferential surface of the lid part.

19. The sample container for the centrifuge according to claim 18, wherein
the step part is formed at a position upper than a center of the axial direction of the lid part.

20. The sample container for the centrifuge according to claim 13, wherein
the lid part includes an outer lid and an inner lid,
the body part and the neck support member are each manufactured by integral molding of a high-polymer resin, and
the outer lid is manufactured by integral molding of metal.

21. The sample container for the centrifuge according to claim 17, wherein
the neck support member is engaged with and attachable to and removable from the lid part and, when mounted, the neck support member is held so as to be able to relatively rotate with respect to the lid part.

22. The sample container for the centrifuge according to claim 21, wherein
the lid part has a groove part formed on the outer circumferential surface and extending in a circumferential direction, and
the neck support member has an inner circumferential surface having formed thereon a projection to be engaged with the groove part.

23. The sample container for the centrifuge according to claim 22, wherein
the lid part has the groove part contiguously formed on the outer circumferential part in the circumferential direction.

24. A rotor for a centrifuge, the rotor having a plurality of holding holes for holding the sample container for the centrifuge according to claim 13.

25. A centrifuge comprising:
the sample container for the centrifuge according to claim 13;
a rotor having a plurality of holding holes for holding the sample container for the centrifuge;
a driving part for rotating the rotor; and
a rotor chamber for accommodating the rotor.
